(19) United States
(12) Patent Application Publication
(10) Pub. No.: US 2003/0014635 A1
(43) Pub. Date: Jan. 16, 2003

(54) Method and mechanism for authenticating licenses of software and other digital products

(76) Inventors: Laurence E. Laforge, Reno, NV (US); Kirk F. Korver, Salt Lake City, UT (US)

Correspondence Address: NATH & ASSOCIATES, 1030 15th STREET, 6TH FLOOR, WASHINGTON, DC, 20005, US

(21) Appl. No.: 10/102,624

(22) Filed: Mar. 20, 2002

Related U.S. Application Data
(60) Provisional application No. 60/276,905, filed on Mar. 20, 2001.

(51) Int. Cl. H04L 9/00

(52) U.S. Cl. 713/176

(57) ABSTRACT

In a novel fashion, the invention employs bar codes and networks to facilitate and standardize the authentication of software licenses, or licenses of other digital content, such as audio and video recordings. The software or other digital content may be purchased along with the license, or the license may be obtained separately from the software or digital content. The former pertains in particular to so-called shrinkwrapped software that is distributed on storage media. Media types include, but are not limited, to compact disks (CDs), digital versatile disks (DVDs), magnetic diskettes, and magnetic tape.

### BACKGROUND OF THE INVENTION

Software piracy is increasingly problematic, particularly with the advent of software auction websites [Johnston 2001], [SIIA 2001], [Weiss 2000]. According to Microsoft manager Lisa Gurry, casual copying accounts for about three-fourths of the illegal copies of software [Wildstrom 2000]. Similarly, piracy of audio and video products plagues the entertainment industry, especially with the advent of digitized content. The invention provides a range of economical protections against piracy, from modestly secure to extraordinarily secure.

### BRIEF SUMMARY OF THE INVENTION

In a novel fashion, the invention employs bar codes and networks to facilitate and standardize the authentication of software licenses, or licenses of other digital content, such as audio and video recordings.

The invention is a method, typically embodied as a program, or system of cooperating computer programs, aggregate purpose of which is to ensure that licensed software or other digital content is used by authorized users, but only by authorized users. Herein licensed software is taken to mean a computer program, or system of computer programs, ostensibly distinguishable from, but which may contain portions of, the invention. Licensed software includes, but is not limited to, systems software, such as disk utilities and operating systems, as well as user level applications, such as word processors and spreadsheets. Other digital content is taken to mean audio and video recordings, generally those which are copyrighted, or could be accorded a copyright. Video games fall within the definition of licensed software.

Practical use of the invention includes, but is not limited to, constraining the use of licensed software or other digital content to its receipted purchase. The invention may run on any of several computing platforms, such as computers built into terminals for point-of-sales or for shipping packages of licensed software. The invention may also run on a personal or client computer. It may run on a website or network server, or in combination with a web browser. The invention may also run on a device for portable computing. This list of platforms is illustrative and not necessarily exhaustive.

The invention facilitates and standardizes the authentication of software licenses, or licenses for other digital content. The licensed software or content may be purchased along with the license, or the license and software (or license and content) may be obtained by separate means. The former pertains in particular to so-called shrinkwrapped software that is distributed on storage media. Such media include, but are not limited, to compact disks (CDs), digital versatile disks (DVDs), magnetic diskettes, and magnetic tape. Other digital content may be, and frequently is, distributed in a similar manner to that for software.

### BRIEF DESCRIPTION OF THE DRAWINGS

FIG. 1: Specimen machine-readable key, such as that which might be printed onto a customer's receipt.

FIG. 2: Flow diagram of a preferred embodiment of the invention. Relations among the respective components are elaborated under DETAILED DESCRIPTION OF THE INVENTION.

### DETAILED DESCRIPTION OF THE INVENTION

The following scenarios describe typical and beneficial, though not necessarily exclusive, uses of the invention.

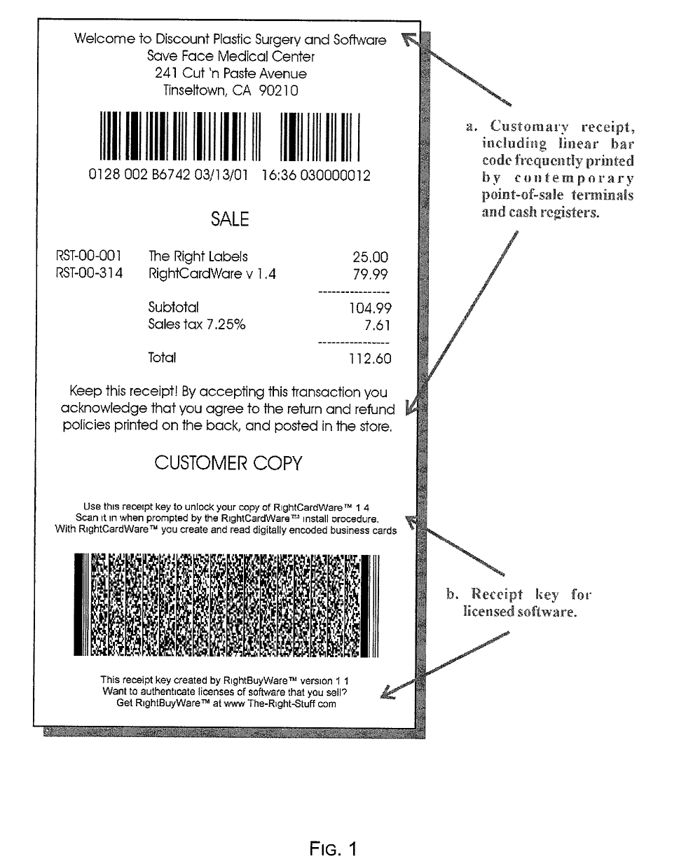

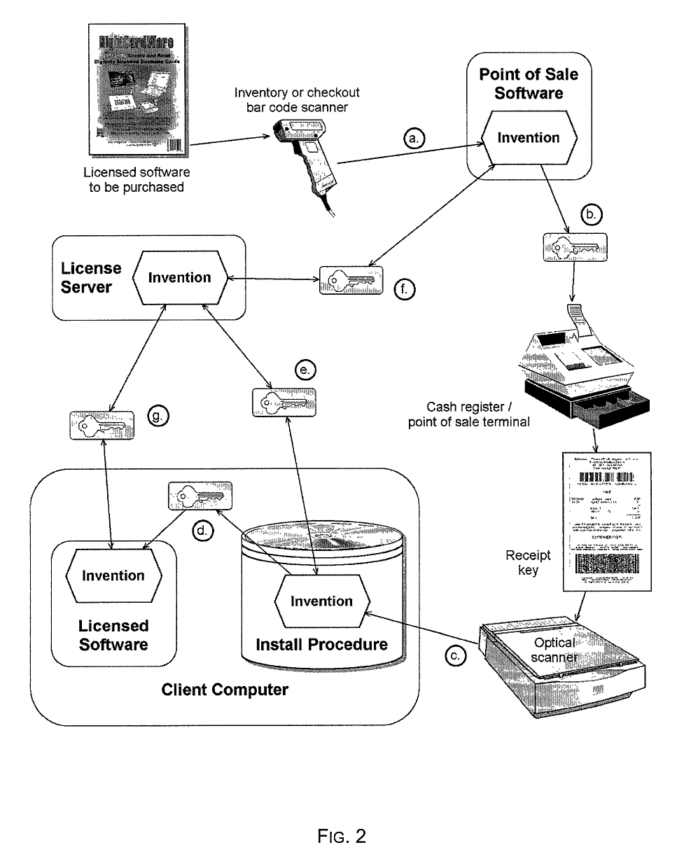

Retailers of licensed software customarily use point-of-sale (POS) software to issue the buyer a paper receipt (Figure 1a). When invoked by POS software, the invention exploits this practice, in a novel fashion, by generating an additional receipt key (FIG. 1b). The receipt key may contain, for example, the serial number of the package sold, and the time, date, and place of sale. Onto the paper receipt, for example, in an area following the itemization of goods sold, the invention prints the value of the key (FIG. 2b). In a preferred form, the invention encodes, and perhaps encrypts, the receipt key in a machine-readable format; such formats include, but are not limited to, bar codes. Machine-readable formats are preferred for reasons of dependability, security, and convenience. For the sake of compatibility with cash registers that cannot print receipts of sufficiently machine-readable quality, the invention may print, or cause to be printed, the numerals or characters corresponding to the value of the receipt key. In a preferred form, the invention exploits standard inventory or checkout scanners to automate the indexing of bar code information on the package of the licensed software (FIG. 2a); this relieves the cashier register clerk of the burden of entering additional information about the licensed software.

In a manifestation envisioned, the invention also comprises an integral part of the licensed software's install procedure running on the client computer (FIG. 2c). In a preferred form, the invention reads an image of the receipt key by way of an optical scanner. In other forms, the invention, acting through the install procedure, may prompt the user to type in the value of the receipt key. The latter may pertain where the cash register cannot print receipts of sufficiently machine-readable quality, or where the user does not have an optical scanner.

At a level achieving modest security, the invention, acting on behalf of the install procedure, verifies the authenticity of the receipt key (FIG. 2d), in the process decrypting the receipt key if it has been encrypted. The invention then advises the licensed software, or perhaps the install procedure for the licensed software, whether the receipt key is authentic. In the use envisioned, the install procedure will install the licensed software if, but only if, the invention authenticates the receipt key. At this level the receipt key created by the invention effects a novel physical embodiment of the license, which must be applied in order for the licensed software to execute.

At a level achieving somewhat stronger security, the invention, acting on behalf of the install procedure, passes the contents, or processed contents, of the receipt key to a license server which may, and generally does, execute on a computer other than the client computer (FIG. 2e). The license server also makes use of the invention, and determines whether the license in question has already been authorized at its predetermined quota (for example, a single installation). If the license has not met its quota then, in the use envisioned, the license server will respond with a registration key that enables the licensed software to run on the client computer. The server then increments the number of authorizations charged against the license's quota. If the license has met its authorized quota then the server may deny the request, or take other action, such as notifying vendors of the software of an attempted breach of security. The license server may foil attempts to impersonate an install procedure by establishing and maintaining a secure dialog with the invention, using, for example, asymmetric encryption based on keys known only to the invention. At this level the invention limits the number of installs authorized by any given receipt key (perhaps to a single installation). The invention therefore inhibits the unauthorized use of the receipt key, or copies thereof.

At a level achieving even stronger security, the invention foils attempts to impersonate authorized POS software, in a fashion analogous to aforementioned mechanisms for establishing the legitimacy of an install procedure (FIG. 2f). In addition to communicating over an effectively secure channel, the invention, acting in concert with the license server, may limit the number of receipt keys that the POS software can autonomously generate, or track these keys, or in fact act as progenitor of such keys.

At a level achieving still stronger security, the invention foils the unauthorized use of the licensed software, as illustrated by FIG. 2g, and as follows. For this case to arise the pirate needs to have surreptitiously duplicated an authenticated, installed copy of the licensed software, along with the registration key, or along with the enabling result of the install procedure having processed the registration key, as described previously. To protect against this contingency, the invention, upon enabling the first install of the licensed software, algorithmically generates a signature of the client environment. Examples of the client environment include the hardware or software configuration of the client computer, the configuration of the computers and peripherals on the client's local intranet, and the client computer's internet protocol address. In combination with the registration key, this signature forms a logical foundation whereby the invention enables the licensed software to execute. With signature generation and validation in effect, the invention binds the client environment to the receipted purchase.

Continuing the case illustrated by FIG. 2g, the invention may store the signature on the client computer, perhaps encrypted. The invention may also store the signature on the license server, or in a location accessed via the invention executing on the license server or client, or elsewhere, with access to the signature perhaps provided by another program acting in concert with the invention. The latter case is particularly pertinent to so-called application service provider (ASP) software, wherein substantive features of the licensed software execute on a computer other than the client computer. The invention in this form is especially beneficial, since ASP software must in general authenticate its client relatively frequently. To validate a signature, the invention may employ an approximation heuristic, such as those based on neural networks, for determining that the client environment matches that authorized for the license. In this or similar fashion, the invention minimizes inconvenience to authorized users who may have made minor changes to their computer's configuration.

The invention encompasses subsets and combinations of features as heretofore described. In the case illustrated by FIG. 2g, for example, ASP software may employ the capabilities of the invention for generating and validating license keys, but not invoke its features for generating and validating client signatures. This particular option tends to reduce the overall computational burden and development cost, albeit with some reduction in beneficial security.

The invention also encompasses materially similar variations of subsets and combinations heretofore described. As a simple example, the invention affords beneficial security even if the bar code scanning illustrated in FIG. 2a is replaced by manual entry of the product code for the licensed software. As another example, vendors may use the invention to generate or print media keys that are packaged with the software. A media key can be used to augment, or perhaps supplant, the receipt key illustrated in FIG. 1a. A media key can augment the receipt key by decreasing the amount of information that needs to be generated by the receipt key, or by further binding the software media to its purchase. The former, for example, may permit the POS software at the cash register to print a one-dimensional bar code instead of a two-dimensional bar code. To bind the software media to its purchase, vendors may, for example, use the invention to generate a key that is printed onto the compact disk that contains the install procedure for the licensed software. In a substantively similar variation, a media key can supplant a receipt key. This latter option tends to reduce the overall computational burden and development cost, albeit with some reduction in information about the purchase and, therefore, a reduction in beneficial security.

The invention also encompasses applications that are materially similar to authentication of software purchased at retail points of sales. In warehouses or facilities that ship or fulfill orders for licensed software, for example, the process whereby orders are accepted may substitute for the POS steps illustrated in FIG. 2a and b. In this case, and in a fashion akin to FIG. 2c, the invention generates a receipt key that is printed onto the packing slip, or onto other paper that is shipped with the media kit containing the install procedure. Alternatively, the shipper may mail only a receipt key, and provide alternative means, such as web-based downloads, for placing the licensed software into the user's hands. Moreover, a receipt key need not necessarily be paper, but may be made of other material, or may be rendered in virtual form. As an example of the latter, the invention may be used for web-only transactions, wherein the steps illustrated in FIG. 2a, b, and c are replaced by client-server interactions. This list is not necessarily exhaustive.

The invention also pertains to authentication of any product which may be rendered in digital form. Such products include, but are not restricted to, audio, video, and audio-visual recordings. Under this scenario, the playback device is, or contains, a client computer (FIG. 2d); the receipt key may accompany, be embedded in, or be affixed to the media. For practical reasons, it may not be feasible to require that a computerized playback device be connected to a network. Therefore, a likely manifestation of this scenario would exclude the step illustrated in FIG. 2g.

It is understood that the invention is capable of further modification, uses and/or adaptations following in general the principle of the invention and including such departures from the present disclosure as come within known or customary practice in the art to which the invention pertains, and as may be applied to the essential features set forth, and fall within the scope of the invention, with specific claims enumerated henceforth.

We claim:

1. A method for authenticating license of software and other digital content comprising
a receipt or media key;
authentication of the receipt key, or media key, that enables use of the software or other digital content

2. The method as recited in claim 1, where the receipt or media key is generated at a point-of-sale, distribution center, or manufacturing facility.

3. The method as recited in claim 1, where the receipt or media key is machine-readable.

4. The method as recited in claim 1, where the receipt or media key contains a bar code.

5. The method as recited in claim 1, such that authentication is performed when the software or other digital content is installed or loaded.

6. The method as recited in claim 1, such that a license server enables or denies use of the software or other digital content.

7. The method as recited in claim 1, such that the receipt or media key is generated at the point-of-sale, distribution center, or manufacturing facility under the control, partial or effectively complete, of a license server.

8. The method as recited in claim 1, such that use of the software or other digital content depends on permissions, or signatures of permissions, binding the license to the client environment.

9. The method as recited in claim 1, wherein substantive features of licensed software or other digital content execute on, or reside in, an environment other than the client's.

10. A system with means for automating the method of claim 1.

11. A system with means for automating the method of claim 2.

12. A system with means for automating the method of claim 3.

13. A system with means for automating the method of claim 4.

14. A system with means for automating the method of claim 5.

15. A system with means for automating the method of claim 6.

16. A system with means for automating the method of claim 7.

17. A system with means for automating the method of claim 8.

18. A system with means for automating the method of claim 9.
